(19) United States
(12) Patent Application Publication
(10) Pub. No.: US 2007/0030419 A1
(43) Pub. Date: Feb. 8, 2007

(54) Liquid crystal display having polarizer with diffusing particles

(75) Inventor: Li-Chun Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/500,187

(22) Filed: Aug. 7, 2006

(30) Foreign Application Priority Data
Aug. 5, 2005 (CN) 200510036446.0

(51) Int. Cl. G02F 1/1335

(52) U.S. Cl. 349/96

(57) ABSTRACT

A liquid crystal display (200) includes a liquid crystal display panel (210) and a backlight module (220). The liquid crystal display panel has a first substrate (211), a second substrate (213), and a liquid crystal layer (212) interposed between the first and second substrates. A first polarizer (214) is attached to a top outer surface of the first substrate. A second polarizer (215) is attached to a bottom outer surface of the second substrate and has a plurality of diffusing particles (216) coated on either or both of opposite surfaces thereof.

### BACKGROUND OF THE INVENTION

1. Field of the Invention

The present invention relates to a liquid crystal display having a polarizer, the polarizer being coated with diffusing particles.

2. General Background

Liquid crystal displays (LCDs) are one of the most popular flat displays because of their thin profile and low power consumption. A conventional LCD basically includes an LCD panel and a backlight module. Because liquid crystal used in the LCD panel is not self-illuminating, the backlight module is employed to provide uniform and adequate illumination for the LCD panel.

FIG. 2 is a schematic, exploded, side view of a conventional LCD 100. The LCD 100 includes an LCD panel 110 and a backlight module 120, which are attached together in a frame 130 and cooperatively define an image display area.

The LCD panel 110 has a first substrate 111, an underlying second substrate 113, and a liquid crystal layer 112 interposed between the first and second substrates 111, 113. A first polarizer 114 is attached to a top outer surface of the first substrate 111, and a second polarizer 115 is attached to a bottom outer surface of the second substrate 113.

The backlight module 120 has a reflector 127, and a plurality of cold cathode fluorescent lamps (CCFLs) 126 disposed above the reflector 127. The backlight module 120 also has a first diffuser 121, a first light collecting film 122, a second light collecting film 123, a second diffuser 124, a light guide plate 125, which are arranged in that order from top to bottom above the CCFLs 126 and the reflector 127. Light emitted by the CCFLs 126 reaches the light guide plate 125 directly, or indirectly after being reflected by the reflector 127. The light sequentially passes through the light guide plate 125, the second diffuser 124, the second light collecting film 123, the first collecting film 122, and the first diffuser 121. Thereby, the backlight module 120 provides a uniform planar light source for the LCD panel 110.

The first and second diffusers 121, 124 of the backlight module 120 can enhance the uniformity of light provided by the planar light source. However, the backlight module 120 requires many optical films, which complicates the assembly process and increases costs. Furthermore, the first and second diffusers 121, 124 are generally very thin, and are easily creased. Once creased, the first and/or second diffuser 121, 124 will typically retain a permanent crease mark. The crease mark is liable to distort images provided by the LCD panel 110 and lower the display quality of the LCD 100.

What is needed, therefore, is an LCD that can overcome the above-described problems.

### SUMMARY

Embodiments of the invention provide a liquid crystal display panel and a liquid crystal display incorporating the liquid crystal display panel. The liquid crystal display requires relatively few optical films. This simplifies steps required in the fabrication of the liquid crystal display. Also, it helps to reduce the risk of occurrence of optical film crease marks in the liquid crystal display.

One embodiment of the invention provides a liquid crystal display panel. The liquid crystal display panel has a first substrate, a second substrate, and a liquid crystal layer interposed between the first and second substrates. A first polarizer is attached to a top outer surface of the first substrate. A second polarizer is attached to a bottom outer surface of the second substrate. The second polarizer has a plurality of diffusing particles coated on either or both of opposite surfaces thereof.

Another embodiment of the invention provides a liquid crystal display. The liquid crystal display includes a liquid crystal display panel and a backlight module, which are attached together in a frame and cooperatively define an image display area. The liquid crystal display panel has a first substrate, a second substrate, and a liquid crystal layer interposed therebetween. A first polarizer is attached to a top outer surface of the first substrate. A second polarizer is disposed on a bottom surface of the second substrate. The second polarizer has a plurality of diffusing particles coated either or both of opposite surface thereof. The backlight module is disposed adjacent to the second polarizer of the liquid crystal display panel.

Unlike in a conventional LCD, the above-described liquid crystal display panel has a polarizer coated with tiny diffusing particles to diffuse light. Thus, the number of the diffusers needed in the accompanying backlight module can be reduced. This also means that the risk of occurrence of diffuser crease marks in the backlight module is reduced.

A detailed description is given below with reference to the accompanying drawings.

### BRIEF DESCRIPTION OF THE DRAWINGS

Embodiments of the invention can be more fully understood by reading the subsequent detailed description and examples with references made to relevant of the accompanying drawings, wherein:

FIG. 1 is a schematic, exploded, side view of an LCD of an exemplary embodiment of the invention; and

FIG. 2 is a schematic, exploded, side view of a conventional LCD.

### DETAILED DESCRIPTION OF PREFERRED EMBODIMENTS

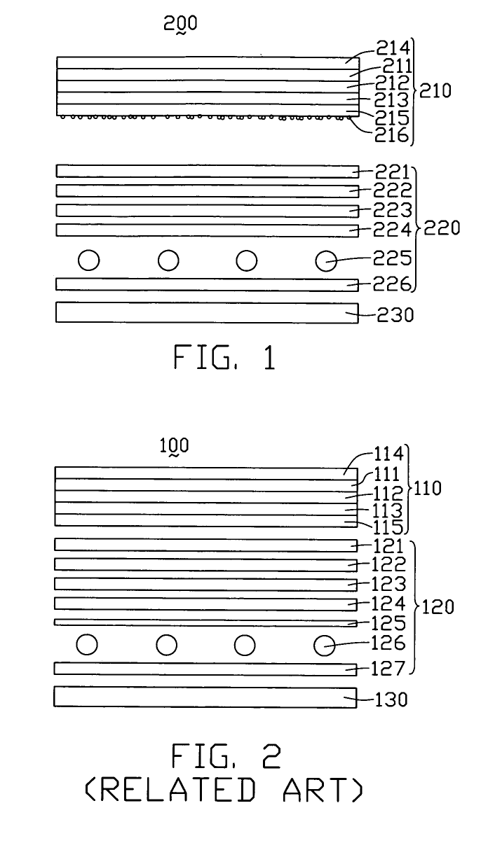

FIG. 1 is a schematic, exploded, side view of an LCD of an exemplary embodiment of the invention. The LCD 200 includes an LCD panel 210 and a backlight module 220, which are attached together in a frame 230 and cooperatively define an image display area. The LCD panel 210 has a first substrate 211, an underlying second substrate 213, and a liquid crystal layer 212 interposed between the first and second substrates 211, 213. A first polarizer 214 is attached to a top outer surface of the first substrate 211, and a second polarizer 215 is attached to a bottom surface of the second substrate 213.

The backlight module 220 has a reflector 226, and a plurality of cold cathode fluorescent lamps (CCFLs) 225 (or alternatively a plurality of light emitting diodes) disposed above the reflector 226. The backlight module 220 also has a first light collecting film 221, a second light collecting film 222, a diffuser 223, and a light guide plate 224 stacked in that sequence from top to bottom over the CCFLs 225.

The first and second polarizers 214, 215 are made of triacetyl cellulose (TAC) or the like. A transparent adhesive is coated on a bottom surface of the second polarizer 215, and a plurality of diffusing particles 216 and sprayed on the bottom surface of the second polarizer 215 so that the diffusing particles 216 are attached to the bottom surface via the transparent adhesive. The transparent adhesive can be a UV-curable (ultraviolet light curable) or heat curable adhesive. The diffusing particles 216 can be silica particles, which can have an average diameter of 15 nm. The diffusing particles 216 provide this part of the LCD panel 210 with light diffusing capability. In preparing the diffusing particles 216 for spraying, a 500 ml three-necked flask made of glass and equipped with a stirring device, a thermometer and a reflux condenser can be provided. 200 g of a dispersion of 30% by weight of silica particles of an average particle diameter of 15 nm in isopropanol is prepared in the flask. After spraying, the transparent adhesive is solidified by exposure to ultraviolet light or heat.

The diffusing particles 216 can further or alternatively be coated on a top surface of the second polarizer 215 that is adjacent to the second substrate 213. The diffusing particles 216 are attached to the top surface of the second polarizer 215 via a transparent adhesive, and provide this part of the LCD panel 210 with light diffusing capability. In particular, after a spraying process, the transparent adhesive is solidified by exposure to ultraviolet light or heat. The second polarizer 215 having the diffusing particles 216 attached thereon can then be pasted onto an inner surface of the second substrate 213.

Light emitted by the CCFLs 225 reaches the light guide plate 224 directly, or indirectly after being reflected by the reflector 226. The light sequentially passes through the light guide plate 224, the diffuser 223, the second light collecting film 222, and the first light collecting film 221. The light is focused within a range of predetermined angles after having passed through the second and first light collecting films 222, 221. The focused light enters the LCD panel 210. Thereby, the backlight module 220 can provide a uniform planar light source for the LCD panel 210.

The light is then polarized and scattered by the second polarizer 215 having the diffusing particles 216, and sequentially passes through the second substrate 213, the liquid crystal layer 212, the first substrate 211, and the first polarizer 214.

The LCD panel 210 also has a color filter layer (not shown) formed on the first substrate 211 adjacent to the liquid crystal layer 212, and a plurality of thin film transistors formed on the second substrate 213 adjacent to the liquid crystal layer 212.

In summary, unlike in a conventional LCD, the above-described LCD panel 210 has the second polarizer 215 coated with tiny diffusing particles 216 to diffuse light. Thus, the number of the diffusers needed in the accompanying backlight module 220 can be reduced. This also means that the risk of occurrence of diffuser crease marks in the backlight module 220 is reduced.

While the invention has been described by way of examples and in terms of preferred embodiments, it is to be understood that the invention is not limited thereto. To the contrary, it is intended to cover various modifications and similar arrangements, as would be apparent to those skilled in the art. Therefore, the scope of the appended claims should be accorded the broadest interpretation so as to encompass all such modifications and similar arrangements.

We claim:

1. A liquid crystal display panel, comprising:
a first substrate, a second substrate, and a liquid crystal layer between the first and second substrates;
a first polarizer provided at the first substrate; and
a second polarizer provided at the second substrate, the second polarizer having a plurality of diffusing particles coated on either or both of opposite surfaces thereof.

2. The liquid crystal display panel as claimed in claim 1, wherein the diffusing particles are coated on either or both of the opposite surfaces of the second polarizer via a transparent adhesive.

3. The liquid crystal display panel as claimed in claim 1, wherein the diffusing particles are coated on a surface of the second polarizer that is adjacent to the second substrate via a transparent adhesive.

4. The liquid crystal display panel as claimed in claim 1, further comprising a color filter layer provided at the first substrate adjacent to the liquid crystal layer, and a plurality of thin film transistors provided at the second substrate adjacent to the liquid crystal layer.

5. A liquid crystal display, comprising:
a liquid crystal display panel comprising:
a first substrate, a second substrate, and a liquid crystal layer between the first and second substrates;
a first polarizer provided at the first substrate; and
a second polarizer provided at the second substrate, the second polarizer having a plurality of diffusing particles coated on either or both of opposite surfaces thereof; and
a backlight module generally adjacent to the second polarizer of the liquid crystal display panel.

6. The liquid crystal display as claimed in claim 5, wherein the diffusing particles are coated on either or both of the opposite surfaces of the second polarizer via a transparent adhesive.

7. The liquid crystal display as claimed in claim 5, wherein the backlight module comprises a light source.

8. The liquid crystal display as claimed in claim 7, wherein the light source comprises a plurality of cold cathode fluorescent lamps.

9. The liquid crystal display as claimed in claim 7, wherein the light source comprises a plurality of light emitting diodes.

10. A liquid crystal display panel, comprising:
a first substrate, a second substrate, and a liquid crystal layer between the first and second substrates;
a first polarizer provided at the first substrate; and
a second polarizer provided at the second substrate, the second polarizer having a plurality of diffusing particles directly associated therewith.
